(19) United States
(12) Patent Application Publication
(10) Pub. No.: US 2004/0028076 A1
(43) Pub. Date: Feb. 12, 2004

(54) Robust data extension for 8vsb signaling

(76) Inventors: Christopher H Strolle, Ft Washington, PA (US); Samir N Hulyakar, Plainsboro, NJ (US); Jeffery S Hamilton, Doylestown, PA (US); Haosong Fu, Levittown, PA (US); Troy A Schaffer, Newtown, PA (US)

Correspondence Address: Allan J Jacobson, Attoney at Law, 13-310 Summit Square Center, Route 413 & Doublewoods Road, Langhorne, PA, 19047, US

(21) Appl. No.: 10/312,931

(22) PCT Filed: Jun. 30, 2001
(86) PCT No.: PCT/US01/41235

(51) Int. Cl. H04L 12/56

(52) U.S. Cl. 370/466

(57) ABSTRACT

A robust data extension is added to a standard 8VSB digital television transmission system by encoding high priority data packets in a rate 1/2 trellis encoder. The high priority data 1/2 trellis encoded packets are multiplexed with normal data packets and input into the normal data service of an 8VSB system, which further contains a rate 2/3 trellis encoder. The combined trellis encoding results in a rate 1/3 trellis encoding for robust data packets and a rite 2/3 trellis encoding for normal packets. Rate 1/3 trellis encoding provides the substantially equivalent robustness of a 2VSB signal while retaining the backward compatibility characteristics or an 8VSB signal. Four legacy requirements for backward compatibility with existing ATSC compliant receivers and transmitters are met: 1) the modulus of the symbol set for robust data transmission is the same as that for an 8VSB signal; 2) compatibility with existing trellis encoders and decoders is maintained; 3) Reed Solomon parity bytes are transmitted as normal data so that existing receivers do not flag robust data packets as having Reed Solomon parity errors; and 4) MPEG compatibility is maintained by guaranteeing that robust data packets will not appear as false MPEG packets that otherwise could destabilize the existing MPEG decoder.

### FIELD OF THE INVENTION

The present invention relates to a method and apparatus for improving the robustness of digital communications systems.

### BACKGROUND OF THE INVENTION

The American Television Standards Committee (ATSC) transmission format for digital television (DTV) uses an 8 level vestigial sideband (8VSB) technique in which each successive 3 bit symbol is transmitted as one of 8 possible signal amplitudes. In a 4VSB system, each successive 2-bit symbol is transmitted as one of 4 possible signal amplitudes. In a 2VSB system, each successive 1-bit symbol is transmitted as one of 2 possible signal amplitudes. A 2VSB signal (or 4VSB signal) is more robust than an 8VSB signal because the distance between permissible signal levels is greater, making the transmitted signal more impervious to noise bursts and signal distortions.

It would be desirable to add a robust extension to the ATSC transmission format to enable the TV broadcasters to serve both the HDTV fixed receiver market and the portable market. Simultaneously, there has been a recent proposal within the ATSC to add “training packets” to the ATSC signal to enhance the receivability of the current DTV signal. The ATSC format was designed primarily for fixed reception and is not currently well optimized for robust reception. The only suggestion to date for a robust mode for the ATSC standard was the use of a 2VSB signaling mode during robust transmissions. Unfortunately, a 2VSB signaling mode is not backward compatible with the existing 5VSB format for a number of reasons. First of all, 2 level signaling would render the current generation of advanced demodulator IC's that utilize blind equalization techniques obsolete. When the ATSC format was originally adopted, it was believed that the training sequence, which occur every 24 milliseconds, would be sufficient for tracking both static and dynamic multi-path. It has been determined through extensive field-testing that the repetition rate of the training sequence is too low to track dynamic multi-path. The problem of tracking dynamic multi-path changes occurring in less than 24 milliseconds has been partially solved by a number of the newer generation of receivers by utilizing blind equalization to acquire the VSB signal. One particularly effective type of blind equalization is the Constant Modulus Algorithm (CMA) that uses a third order error function to effectively “open the eye” so that decision directed equalization can be used. The CMA error function used for VSB is a real only valued signal since the received symbols at the slicer are real only since the q-component is the Hilbert transform of the real part. The introduction of 2VSB symbols interspersed with 8VSB symbols would cause the CMA error function to be mismatched. The detailed cause of the mismatch is outlined below.

The symbol set for 8VSB is {−7, −5, −3, −1, 1, 3, 5, 7}. In order to make 2VSB signaling backward compatible when operating in a decision directed mode, the transmitted symbols should be bipolar and from the 8VSB set. A natural choice would be {+5, −5}, however, it can be shown that this chosen symbol set as well as any other bipolar set from the 8VSB set is incompatible with the 8VSB set itself when utilizing blind equalization such as CMA. The incompatibility arises since the constant modulus for the 2VSB symbols is different from the one needed for the 8VSB symbols.

The modulus for the 8VSB symbols is: E{X**4}/E{X**2} where X is the transmitted symbols and E is the expected value. The required modulus to drive the received symbols to the desired levels of {−7, −5, −3, −1, 3, 5, 7} so that decision directed equalization can be used is:

((−7)⁴+(−5)⁴+(−3) ⁴+(1)⁴+(3)⁴+(5)⁴+(7)⁴)/((−7)²+(−5)²+(−3)²+(−1)²+(1)²+(3)²+(5)²+(7)²)=37.

However, the modulus for the 2VSB symbol set {−5, 5} is:

((−5)⁴+(5)⁴)/((−5)²+(5)²)=25.

And the modulus for the 2VSB symbol set {−7, 7} is

((−7)⁴+(7)⁴)/((−7)²+(7)²)=49.

Therefore it can be seen that either form of 2VSB: {−5, 5} or {−7, 7} is incompatible with 8VSB signaling with respect to the modulus requirements for blind equalization. Therefore, if the 2VSB signaling format is used with existing (i.e., legacy) demodulator ICs that use the 8VSB modulus for blind equalization, the equalized symbol levels will be incompatible with the levels needed for decision directed mode. More specifically, if the 2VSB symbols {−5, 5} are interspersed with 8VSB symbols, the equalized received symbols will be greater in level than expected by legacy (i.e., existing) receivers, reflecting the fact that the expected value of the 2VSB symbols is lower that the 8VSB symbols on average. The blind equalizer then will compensate for this level mismatch by creating a new symbol set with an effective modulus of 37. Conversely, if the 2VSB symbols {−7, 7} are used, the equalized symbols will be lower in level than expected. The mismatch between CMA and decision directed symbol levels is a function of the number of 2VSB symbols injected into the 8VSB symbol stream. Also, the mismatch will lead to a failure to acquire the signal when there is severe multi-path and/or significant gaussian noise and the critical handoff from blind to decision directed is compromised.

The introduction of training packets to aid equalization reduces the payload capacity of the channel. Each 8VSB symbol carries 2 bits of information and 1 bit of redundancy introduced by the trellis code. This type of coding is referred to as 2/3 rate trellis coding. Symbols that are derived from known training packets contain 0 bits of information and 3 bits of redundancy. Two of the redundant bits come from the known training packet in the payload itself and 1 additional bit of redundancy from the trellis code. These types of symbols are referred to as 0/3 rate symbols. Since 0/3 rate symbols carry no information, they are simply overhead, and are to be avoided if at all possible.

### SUMMARY OF THE INVENTION

The present invention is embodied in the ATSC compliant embedding of information bearing symbols that 1) create a more robust tier of service, and simultaneously 2) enhance the performance of the equalizer in the receiver, thereby improving the receivability of the normal tier of service.

In addition to creating a more robust tier of service, backward compatibility with existing ATSC compliant receivers and transmitters must be maintained. The legacy requirements of the existing ATSC standard dictate that the robust tier of service must meet four requirements of backward compatibility:

8 VSB

Robust data packets must appear at the receiver to have the characteristics of an 8 VSB signal. In particular, the modulus of the symbol set for robust data transmission must be the same as that for an 8 VSB signal.

Trellis Encoding and Decoding

Robust data packets must use the existing trellis encoder at the transmitter and the existing trellis decoder at the receiver.

Reed Solomon coding

Robust data packets must generate valid Reed Solomon parity bytes so that existing receivers do not flag robust data packets as having Reed Solomon parity errors.

MPEG Compliance

Robust data packets must maintain the MPEG format. In particular, robust data packets must not appear as false MPEG packets that can destabilize the existing MPEG decoder.

All of the above four compatibility requirements are met by the system of the present invention.

8 VSB and Trellis Encoding and Decoding

Assume that one or more high priority data packets (also referred to as robust data packets) at the transmitter represent the data to be transported by the presently added robust tier of service while maintaining 8VSB and trellis encoding compatibility. The high priority data packets are first encoded in a rate 1/2 trellis encoder and multiplexed with normal priority data packets. The additional 1/2 rate trellis encoder and robust/normal packet multiplexer represent the hardware added to the existing 8VSB transmitter to implement the present invention. The 1/2 rate trellis encoded packets multiplexed with normal packets are then inserted into the unmodified data service of the existing 8VSB transmitter in synchronism with the system frame sync signal to form a transmitted tier of robust data packets.

The standard 8VSB system normally includes a rate 2/3 trellis encoder as part of the existing ATSC system standard. The result of inserting the rate 1/2 trellis encoded high priority data packets into a standard ATSC transmission system is that the high priority data packets are further encoded in a rate 2/3 trellis encoder. The net result of the double trellis encoding (first at a rate 1/2, then at a rate 2/3) is a rate 1/3 trellis encoded signal during robust data packet transmission. A rate 1/3 trellis encoded signal, transmitted in the 3-bit symbol interval of an 8VSB signal, has substantially more robustness as compared to a 1-bit 2VSB signal. At the same time, the present invention preserves the 8VSB signal characteristics for all other system purposes. Thus, the advantages of a 2VSB system are achieved, while the backward compatibility of an 8VSB trellis encoded system is retained.

In addition, the ATSC standard provides for integral pre-coding of one of the data bits (X2).

Integral pre-coding results in a performance loss of at least 1.25 dB for robust data. Integral pre-coding is defeated (i.e., cancelled or undone) by first differentiating the robust data. Since differentiation is the reverse operation of integration, the net effect is to cancel the effect of the integral pre-coder. The advantage of defeating (undoing) the integral pre-coder during robust data transmission is that it produces a systematic trellis code.

In accordance with another aspect of the present invention, potential errors resulting from the pre-coder defeat are avoided by the use of a selectable inversion or non-inversion of the transmitted data. Errors, which are manifested as a phase inversion, can occur upon a transition from robust to normal packet transmission. The difference between the actual and computed normal data is monitored, and any difference is detected and used to activate an invert/non-invert circuit. Operation of the invert/non invert circuit avoids potential phase errors in the normal data resulting from defeat of the integral pre-coder during robust data transmission.

Reed Solomon Coding

With respect to Reed Solomon encoding compatibility, robust data packets must transmit Reed Solomon parity bytes as normal data so that existing receivers do not flag robust data packets as having Reed Solomon errors. However, transmitting Reed Solomon parity bytes as normal data compromises the reliability of the robust data packet. In effect, robust data packets lose the benefit of Reed Solomon coding because the Reed Solomon parity bytes themselves are not a robust data transmission. Specifically, during adverse transmission channel conditions wherein normal data is not receivable, the Reed Solomon parity bytes will not be received. In accordance with a further aspect of the system of the present invention, an additional level of Reed Solomon coding is encapsulated within the robust data packet.

MPEG Compliance

With respect to MPEG compliance, high priority packets are made smaller than the standard MPEG data packet. In the invention of the present system, a data pre-processor adds parity bytes to the robust data packet, to create a robust MPEG data packet. To ensure backward compatibility, the header bytes for the robust MPEG data packet are encoded with a NULL packet header and encoded as normal data.

System with Compatible Robust Data Extension

The resulting transmitted data stream contains normal (rate 2/3 trellis encoded) data packets multiplexed with high priority (rate 1/3 trellis encoded) data packets. The receiver detects the reserved bit field of the standard ATSC frame sync signal and stores the received robust mode tier control code. Frame synchronization of the trellis encoded high priority data packets permits the receiver to synchronously switch to robust mode whenever a robust data packet is being received and switch back to normal mode whenever a normal data packet is being received. In robust mode, the receiver of the present invention uses the received robust data packets to 1) receive data with more reliability and additionally 2) to more rapidly adjust the equalizer to track transient channel conditions such as dynamic multipath. Legacy receivers ignore the reserved bit field.

Thus, the system of the present invention adds a robust tier of service to a standard 8VSB transmitter while preserving backward compatibility for existing 8VSB receivers. In addition, existing unmodified 8VSB transmitters need no internal modifications for use with the present invention other than to install the additional hardware required to implement the robust tier of service. A further aspect of the invention is that the new information-bearing symbols (the robust data packets) are trellis encoded such that the substates of this trellis code are compliant with the ATSC trellis code. Another aspect of the present invention is that ATSC trellis code is strengthened (during reception of robust data packets) such that the receivability of the normal tier (during reception of normal data packets) is improved.

Thus, in the present system, the normal tier of service contains 8VSB symbols that are encoded at a rate of 2/3 and the robust tier of service contains 8VSB symbols that are encoded at a rate of 1/3. The ATSC training signal and segment sync symbols are encoded at a rate of 0/3.

### BRIEF DESCRIPTION OF THE DRAWINGS

FIG. 1 is a block diagram of an ATSC hierarchical transmission system that produces a two-tier symbol stream according to the present invention.

FIG. 2 is a detailed block diagram of the robust encoder and 8VSB modulator found in FIG. 1.

FIG. 2a is a detailed block diagram of the robust packet processor found in FIG. 2.

FIG. 2b is a detailed block diagram of Inverter/Non Inverter 34 found in FIG. 2a.

FIG. 2c is a block diagram of a robust data pre-processor in accordance with the present invention.

FIG. 3 is a block diagram of a receiver capable of receiving the two-tiers of service.

FIG. 3A is a detailed block diagram of the demodulator/decoder found in FIG. 3.

FIG. 3B is the block diagram of the effective trellis encoder assuming that all data is robust.

FIG. 3C shows the trellis state transition diagram when two-tier (robust/normal) service is being transmitted.

### DETAILED DESCRIPTION

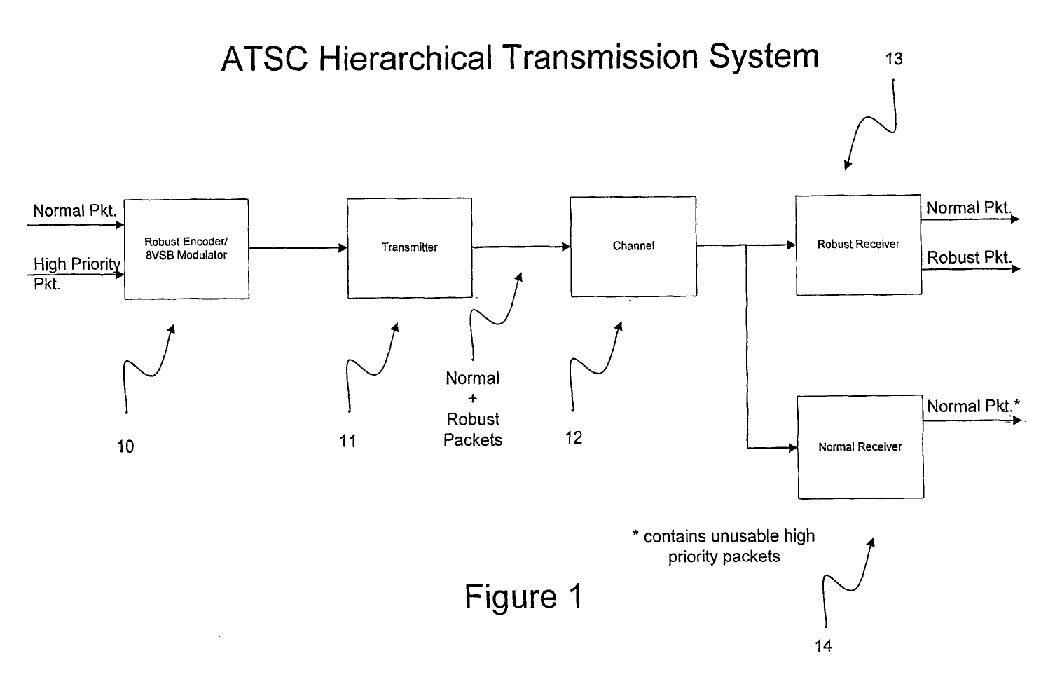

FIG. 1 illustrates the ATSC hierarchical transmission system using the robust data mode. The packets that are to be encoded in a robust mode, are labeled high priority data packets and are merged with the normal packets of the system by robust encoder/8VSB modulator 10. The high priority data packets are assembled using NULL Packet Identifiers (PIDs) that are not valid for the normal packet stream. After processing, the signal is sent to transmitter 11.

Normal and robust data packets are broadcast through the transmission channel 12. Robust receiver 13 processes the received signal and produces two packet streams: the normal packet stream and the high priority stream. The robust receiver receives high priority data packets error free in adverse channel conditions in which the normal packets are unusable due to excessive errors. The normal receiver 14 produces a single packet stream of normal packets (if channel conditions are favorable enough to permit reception). Since the high priority data packets contain Packet Identifiers (PIDs) associated with NULL packets that are not valid for the normal packet stream, the high priority data packets will be discarded by the transport demux in the normal receiver 14, thereby maintaining backward compatibility.

Robust Encoder

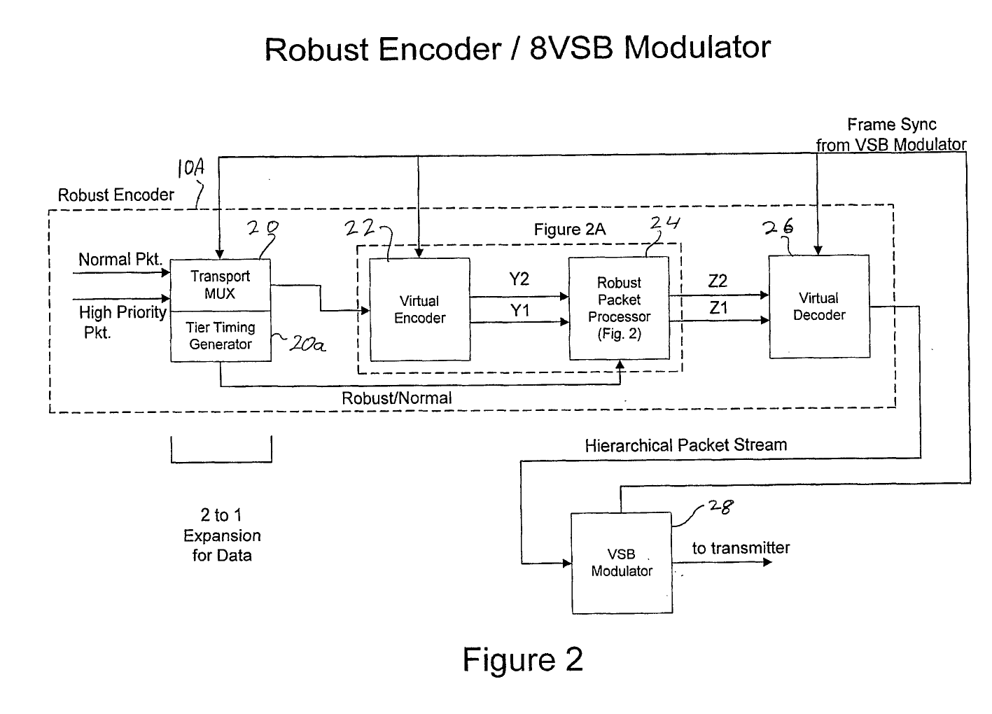

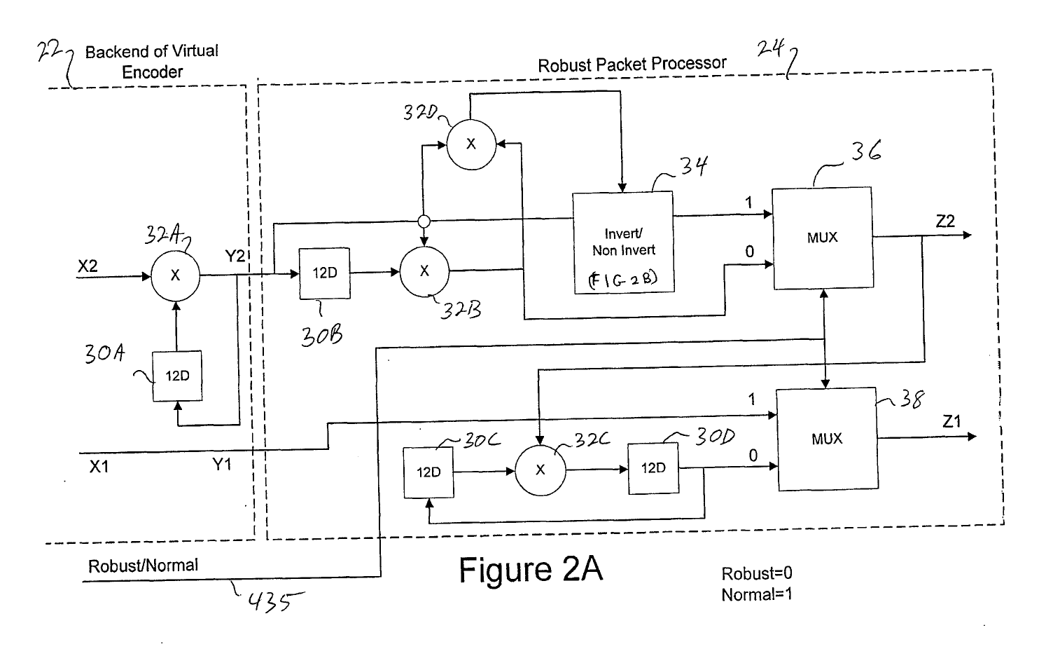

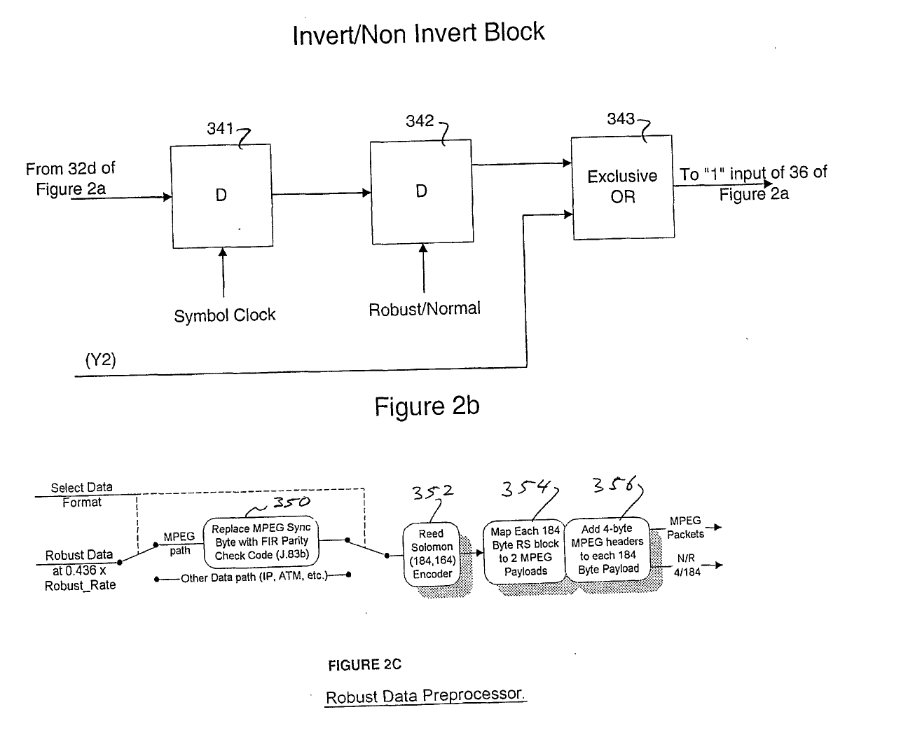

FIG. 2 is a block diagram of a robust encoder in accordance with the present invention. Normal MPEG 2 transport packets (labeled “Normal Pkt.”) are multiplexed with the additional MPEG 2 transport data packets (labeled “High Priority Pkt.”) in transport MUX/Tier Timing Generator 20. The additional data high priority data packets are encoded into a robust tier of service. Since robust data packets are encoded at a rate 1/3, zero filling every other bit position to occupy two transport packets not necessarily contiguous in time expands one data packet. In addition, tier timing generator 20a generates the Robust/Normal (N/R) signal, which synchronizes the insertion of the robust symbols into the symbol stream in the robust packet processor 24. Normal data is indicated by setting N/R=0, while robust data is indicated by setting N/R=1.

The percentage of the total available symbols for robust encoding can vary from 0 to 100%. However, the receiver must know what the percentage of robust packets so that the receiver can synchronize its own tier timing generator to the transmitter tier timing generator 20a. A robust mode tier control code is inserted into the reserved bit field of the ATSC signal. The receiver extracts the robust mode tier control code and uses the stored robust mode tier control code for synchronization. Since legacy receivers ignore the reserved bit field of the ATSC signal, backward compatibility is maintained.

A reasonable choice for the robust mode tier control code is to allow for 32 distinct modes, which is represented by 5 bits in the reserved field of the frame synchronization. In such case, robust mode=0 is defined as 0% robust data, while robust mode=31 is defined as 100% robust data. Between 0 and 100% robust data, the percentage of symbols available for robust data varies linearly with the robust mode tier control code. For example, when the robust mode tier control code is equal to 7, then 25% (8/32) of the available symbols are devoted to normal data and the remaining 75% of the available symbols are devoted to robust data. In addition, for each robust mode tier control value, the location and pattern of the robust data packets with respect to the normal data packets and the frame synchronization are predefined. Once the receiver has stored the robust mode tier control code, the receiver knows where to find each of the robust data packets in the received data stream, in accordance with the selected robust mode tier control code.

It is advantageous to add error correction coding to the 5 robust mode tier control bits in the reserved field to ensure that the tier control code is also robust and recovered error free. After multiplexing 20, the transport stream is encoded by a virtual encoder 22.

The robust encoder/8VSB modulator of FIG. 2 includes a virtual encoder 22 and a virtual decoder 26. A robust packet processor 24 processes the intermediate received data stream. The purpose of the virtual encoder 22 and virtual decoder 26 is to simulate the process that occurs within the existing VSB modulator 28. In such manner, the hierarchical packet stream can be input to the existing VSB modulator 28. Other than requiring access to the frame sync signal from the existing VSB modulator 28, no modifications are needed. In the future, a robust packet processor 24 may be incorporated within the VSB modulator 28.

The virtual encoder, robust packet processor 24 and virtual decoder 26 need not be three distinct processes but are illustrated in this fashion to show the steps necessary to ensure ATSC compliance. By definition the transport stream will be compliant since the (existing) ATSC compliant VSB modulator 28 will process it. The virtual encoder 22 is ATSC compliant and produces VSB symbols that are compliant as well. VSB Symbols are then modified by robust packet processor 24 and decoded by the virtual decoder 26. The output of the virtual decoder 26 contains the MPEG transport stream carrying the two-tiers of service. Frame sync from the existing VSB modulator 28 is used by the virtual decoder 26, the virtual encoder 22 and transport MUX/Tier timing generator 20 to synchronize the insertion of the robust data packets into the appropriate time slots.

FIG. 2a is a detailed description of the backend of the virtual encoder 22 and the robust packet processor 24. In accordance with standard nomenclature, X1 and X2 are information data bits to be encoded, Z2, Z1 and Z0 are the trellis-encoded bits and Y2 and Y1 are intermediate bits created in digital signal processing.

The ATSC format provides for integral pre-coding of the X2 data bit. Integral pre-coding (a legacy of the ATSC format) was originally intended to deal with co-channel interference using a comb filter that has been made obsolete by the use of modern notch filtering techniques. It is desirable to defeat (i.e., undo or cancel) the integral pre-coder during the transmission of robust data packets. The robust packet is conditioning to defeat integral pre-coding by differentiating it. Since differentiation is the reverse operation of integration, the net effect is to cancel the effect of the integral pre-coder. If the integral pre-coder is not defeated during robust data transmission, and the integral pre-coder is allowed to randomly advance states, a performance loss of at least 1.25 dB occurs. Additional loss can occur since the integral pre-coding of the X2 stream doubles the effective bit error rate of the decoded X2 bit in the receiver. The advantage of defeating (undoing) the integral pre-coder during robust data transmission is that it produces a systematic trellis code.

As shown by FIG. 2a the integral pre-coding of the x2 stream by exclusive or (XOR) 32a and delay 30a produces the Y2 stream in the virtual encoder 22. It is more convenient to modify the Y2 and Y1 data streams to produce Z2 and Z1 data streams. The first step of the robust packet processor 24 is to remove the effects of the integral pre-coding by differentiating the Y2 stream with delay 30b and XOR 32b. Multiplexer 36 selects the differentiated Y2 data from the “0” input in response to the Robust/Normal signal 435 asserted low. When high, the Y2 bit is selected from the “1” input to the multiplexer 36.

In effect, if a disparity exists between the differentiated Y2 and the Y2 bit at the time of resumption of normal symbol transmission, the Y2 bit is inverted in 34. The combination of XOR 32d controlling invert/non invert block 34 ensures that the polarity of the transmitted Z2 bit is correct when transitioning from a robust to a normal symbol. The inversion or non inversion of Y2 in element 34 ensures that the differential decoder in existing receivers works properly, ensuring backward compatibility.

FIG. 2b is a detailed description of the invert/non-invert inversion process 34 of FIG. 2a. As indicted above, any disparity (detected by XOR 32d of FIG. 2a) between the differentiated Y2 and the Y2 bit at the time of transition from robust to normal symbol transmission is used in 34 to invert the transmitted Y2 bit. As shown in FIG. 2b, the output of XOR 32d from FIG. 2a is delayed one symbol clock by delay element 341 and then sampled by the Robust/Normal signal and held in delay 342. The signal held in delay 342 is then used to invert or not invert (Y2) in XOR 343. The output of XOR 343 is coupled to the “1” input of MUX 36 in FIG. 2a. Elements 341 and 342 in combination ensure that any disparity that occurs at the time of the last transmitted robust symbol is used to control the inversion or non-inversion of the subsequent normal symbols.

The non-pre-coded x2 is processed by the back to back combination of the virtual decoder 26 and the existing 8VSB encoder to produce the exact same Z2 data bits for the payload portion of the bit stream that was present at the output of the robust packet converter. The differences that still occur between the Z2 stream at the robust packet converter output and the existing VSB modulator output are caused by the normal Reed Solomon parity bytes that are generated for the robust data packets by the existing 8VSB encoder. The Reed Solomon parity bytes created by the virtual encoder are compliant with the zero filled packets whereas in the Reed Solomon bytes created by the existing encoder are compliant with the actual transmitted packet. Since the ATSC compliant Reed Solomon parity bytes are transmitted as normal data, the parity bytes are more prone to errors than the robust data message itself. The normal encoding of parity bytes for the robust packets requires that the robust data packets need their own forward error correction (FEC) parity bytes if they are to use a Reed Solomon correction code. In accordance with the present invention a robust data pre-processor adds the extra parity bytes for the robust data only. The additional parity bytes for robust data are encapsulated within the robust data payload. An example implementation of this robust data pre-processor is described herein below.

As previously noted, Virtual Encoder 22 in FIG. 2 predicts the symbol sequence that will actually be present at the VSB Modulator 28 output. One aspect of this prediction is to determine the states of the pre-coders in VSB Modulator 28, so that the integral pre-coding of the X2 data bit can be defeated for robust data. However, occasionally it is impossible to exactly predict these states since their states are dependent on ATSC parity bytes for robust packets that have not been computed, and cannot be computed at this point since the associated robust payload is still being computed.

Therefore, occasionally the integral pre-coder defeat circuitry needs ATSC parity bytes that have not been computed yet for the robust data packets. The net effect of this dilemma (parity bytes arriving before information bytes) is that worst case, occasionally (for about 1 in 40 robust symbols) the integral pre-coder advances state such that the transmitted robust data packets have the Z2 bit inverted (a phase inversion) relative to the Z1 and Z0 bits. In the latter case, the transmitted code is an inverted systematic code. The inversion of the Z2 bit is a phase ambiguity that must be resolved at the receiver.

Alternatively, the above-described phase ambiguity can be avoided at the transmitter by changing the existing Reed Solomon code and using a non-standard Reed Solomon code. Standard Reed Solomon encoders append the parity bytes to the end of the message. After interleaving, the parity bytes for a particular packet come out before all the information bytes have come out, creating the dilemma for defeating the integral pre-coder circuitry. In Reed Solomon encoding the parity bytes need not be placed at the end of the message in order to create a valid Reed Solomon codeword. However, changing the Reed Solomon code at the transmitter means that existing transmitting station will need to replace the existing 8VSB modulators. In that sense, changing the Reed Solomon code to a non-standard code is not fully backward compatible with the existing ATSC broadcasting equipment. Existing ATSC broadcasting equipment will continue to be compatible with existing receivers. However, to obtain the benefits of robust data transmission (robust data services and more stable normal data services) requires the replacement of the 8VSB modulator.

Therefore, both the legacy receivers expecting the parity bytes to be at the end of the message and the new receivers that know the true placement of the parity and information bytes, will see valid Reed Solomon codewords. In effect, the information bytes and parity bytes are scrambled, but (for the purpose of maintaining backwards compatibility) the legacy Reed Solomon decoders will still see these new codes as valid Reed Solomon code words. As previously indicated, the packet header in each robust data packet has been given a PID corresponding to a NULL packet. Therefore, it does not matter to legacy receivers that the information bytes have been scrambled because legacy receivers will in any event discard high priority data packets as NULL packets

Using non-standard Reed Solomon encoding, the parity byte positions can be placed in the packet, such that after interleaving, all the information bytes come out first, and the Reed Solomon parity bytes, which have not yet been computed, can be calculated from the information bytes that previously come out. Now the Reed Solomon parity bytes can be calculated prior to the parity bytes being processed by the integral pre-coder circuitry, eliminating the phase ambiguity condition previously described. The receiver description for each of the two cases (where the phase ambiguity is resolved at the receiver or the phase ambiguity is resolved at the transmitter) is described in the sections below.

For robust symbol encoding, the Z2 data stream is then trellis encoded to produce the Z1 data stream as shown by delays 30c and 30d and XOR 32c in FIG. 2a. Multiplexer 38 selects between the trellis coded signal at the “0” input or the Y1 signal at the “1” input in response to the Robust/Normal signal. The illustrated trellis code is a 4-state convolutional feedback trellis code that is identical the ATSC trellis code that is used to generate the Z0 bit from the Z1 bit stream. At this point, the Z1 bit stream is a trellis-coded version of the Z2 bit stream. The effect of the virtual decoder 26 (of FIG. 2) on the Z2/Z1 bit streams is significant in respect to the randomizer. The ATSC compliant virtual decoder intentionally derandomizes the Z2 bit differently than the Z1 bit. The effect is to produce Z2/Z1 bit pairs at the existing VSB modulator input that have different randomization patterns applied to them. The randomization disparity between the two bits is removed by the randomizer in the existing VSB modulator, and hence, the Z2/Z1 pairs at the modulator output have had the randomization disparity between them removed, and are exactly the Z2/Z1 bit pair that was present at the Robust Packet Processor output.

The Z1 bit stream at the existing VSB modulator is further trellis encoded to produce the Z0 bit stream. The combined trellis encoder in the robust packet processor and the encoder in the existing VSB modulator form an effective 16 state trellis encoded sequence in which the substates (Z0 bit) are ATSC compliant.

The trellis encoder in the robust packet processor does not advance state when normal ATSC packets or robust parity bytes are being transmitted. The control muxes control whether normal 8VSB or robust symbols are being transmitted. The role of the invert/non-invert block preceding the mux for the Z2 bit inverts the polarity of the Y2 bit when the 8VSB symbol transmission resumes if a disparity exists between the Y2 and differentiated Y2 bit streams. This polarity inversion ensures that the Z2 bit stream is ATSC compliant when differential decoding is preformed on the normal ATSC symbols.

The trellis encoder illustrated was a 16-state trellis code. Trellis codes with more states can also be used. Also, multidimensional trellis codes can be used. In particular, a 4 dimensional trellis code may be well suited for this application since worst case placement of the robust symbols within the frame causes the 4 sub-states within the ATSC trellis to advance for significant periods of time while the super state is held because no robust symbols are being transmitted. Since the sub-state code (ATSC) is less reliable and the 16 state trellis decoder must use the sub-state estimates from the ATSC trellis code alone when normal transmission is occurring, the first symbols at the resumption of robust transmission are less reliable than subsequent symbols, a 4-dimensional code could strength the predictability of these first symbols.

The timing of robust symbol placement is indirectly controlled by the existing VSB modulator itself. The transport MUX inserts the unencoded robust packet synchronized to the VSB field sync signal. This ensures that the robust symbols are placed into known positions within the VSB frame. Different patterns and robust data rates are possible but in practice it should be limited to a finite number since the best way to convey to the receiver what the placement pattern was is through use of the reserve bits in the field sync segment. These bits should be coded to ensure reliable reception when operating under worst case communication channel conditions.

A robust data pre-processor (FIG. 2C) is provided to pre-process high priority data before application to the robust encode/8VSB modulator 10 of FIG. 1. As shown in FIG. 2 and described earlier, the robust encoder 10A multiplexes robust data packets (also called high priority data packets) and the normal packets in one stream. As described earlier, for the robust data packets, the Reed Solomon parity bytes are encoded as normal data (for backwards compatibility purposes) and therefore will have the significantly degraded reliability as compared to the information bytes (which are encoded as robust data). Another backward compatibility problem arises when using the robust data packets as MPEG packets, in that the resulting MPEG packet stream encoded for the VSB Modulator 28 may (with some non-zero probability) result in a valid MPEG packet header. False MPEG packets can destabilize the existing MPEG decoder. The MPEG packet header consists of 4 bytes, one byte of sync, and the other three bytes carrying Packet Identifier (PID) information. It would be desirable to ensure that the robust encoder does not cause valid MPEG packets corresponding to the robust data for existing MPEG decoders.

The robust data preprocessor solves both of the two backward compatibility problems described above (loss of Reed Solomon encoding and false MPEG packets). The main idea is to consider the robust data packet to be a smaller size than the MPEG data packet, add parity bytes to the robust data packet, and create a robust MPEG data packet. To ensure backward compatibility, the header bytes for the robust MPEG data packet are encoded with a NULL packet header and encoded as ‘normal’ data.

FIG. 2c illustrates a robust data preprocessor in more detail. The data preprocessor of FIG. 2c processes (or more accurately pre-processes) high priority data packets in FIG. 1 before the robust data packet is fed to the robust encoder/8VSB modulator 10. Since the robust data may be used for services other than those that result in MPEG packets (e.g. datacasting), an encoding facility for non-MPEG packets is also described. For robust data comprised of MPEG packets, the MPEG standard 47hex sync byte is removed and replaced in 350 with an FIR parity check code as described in ITU J.83 Annex B. The parity check 350 added by the robust data preprocessor of FIG. 2c enables reliable MPEG packet sync detection at the receiver, as well as error detection in the MPEG packet. If the robust data is any other (non-MPEG) protocol, step 350 is bypassed. The information about whether the robust data consists of MPEG data or of some other protocol is sent to the receiver via a robust payload type information bit within the reserved bits of the VSB frame.

The next step within the robust data preprocessor is a (184,164) Reed Solomon encoder 352, which adds 20 Reed Solomon parity bytes to each 164 robust data bytes for a total of 184 bytes. The generator polynomial for the Reed Solomon encoder is the same as that used in the Reed Solomon (207,187) 8-VSB encoder (187 data bytes, 20 Reed Solomon parity bytes and 207 total bytes). The 184-byte Reed Solomon blocks are mapped into two 184-byte packets in step 354 as follows. Every byte is split into two segments of 4-bits each. With the 4 bits designated as A, B, C, and D, a new byte is generated by interspersing zero bits to create a byte: A, 0, B, 0, C, 0, D, 0. Thus each input byte is mapped into two output bytes doubling the data rate. Each 184 bytes output from the Reed Solomon encoder creates two 184-byte MPEG packet payloads. A 4-byte MPEG NULL packet header (includes the 47hex sync byte) is attached to create a compliant MPEG Transport Stream packet at step 356. Legacy receivers ignore MPEG NULL packets, which is essential for backward-compatibility. The 4-byte MPEG NULL header is encoded as normal bytes (the 47 hex sync byte is removed by the VSB modulator). Setting N/R (Normal/Robust) flag as 0 (normal) for the 3-byte header ensures normal encoding for the MPEG header. Existing receivers will throw away the packets corresponding to the robust data, as they would decode the packet header as a NULL packet. The two robust data packets thus generated 354 could be allocated contiguously in a frame (or an even number of packets are allocated within a frame), so that the receiver can accumulate the two packets and implement the Reed Solomon decoding operation.

Since some of the robust data bytes need to be encoded as normal, the virtual encoder 22 must keep track of these bytes as shown in FIG. 2. The virtual encoder 22 includes a Data Randomizer, Reed Solomon encoder, Convolutional Interleaver and the Trellis Code Interleaver in accordance with U.S. provisional patent application serial No. 60/280,944, filed Apr. 2, 2001 (herein referred to as the A/53 specification) The A/53 specification is a proposal submitted to the Advanced Television Systems Committee, 1750K Street, Washington, D.C. 20035 US. The Data Randomizer is the ATSC randomizer, which operates on all bytes, and does not change the N/R signal, except to add delay to account for the latency of the block. The Reed Solomon encoder is the ATSC Reed Solomon (207,187) encoder, which keeps the N/R signal as provided by the Data Randomizer for information bytes. For all Reed Solomon parity bytes including the robust data MPEG packets, the N/R signal is set to normal mode. The Convolutional Interleaver keeps track of the N/R signal corresponding to every byte output by the Reed Solomon encoder by interleaving the N/R signal as well. The Trellis Code Interleaver output are 2-bit nibbles (X2,X1) and also keeps track of the N/R signal corresponding to every byte output by the convolutional interleaver.

The robust packet processor 24 as described earlier in FIG. 2A then operates on the incoming data, switching between normal and robust operation according to the Normal/Robust flag. The rest of the blocks comprise the virtual decoder 26. The Trellis Code Deinterleaver outputs bytes to the Convolutional Deinterleaver, which performs the deinterleaving operation in accordance with the A/53 specification (U.S. provisional patent application serial No. 60/280,944, filed Apr. 2, 2001). The Reed Solomon decoder simply removes the parity bytes for all input packets and the Derandomizer is the ATSC derandomizer.

Robust Decoder

The robust data decoder has a dual role. First, the robust data decoder is used to receive the robust data packets in channel conditions where the normal 8VSB symbols are not receivable, and second, the robust data decoder enhances the receivability of the normal 8VSB symbols. Both modes of operation (normal and robust) utilize the same decoding system. Differences in the processing steps for normal and robust modes are noted below.

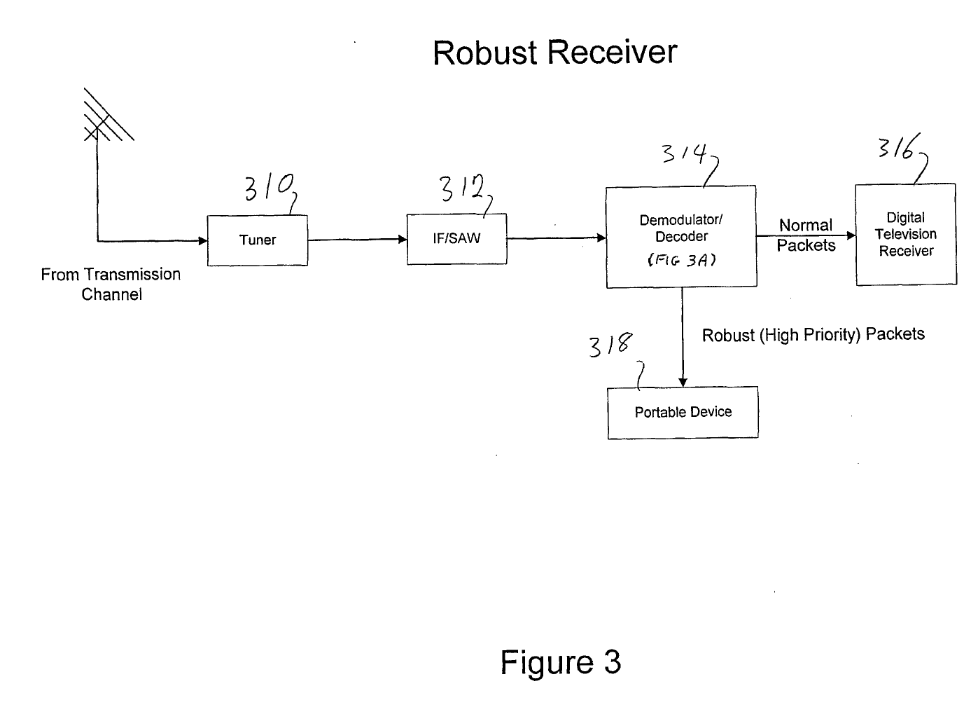

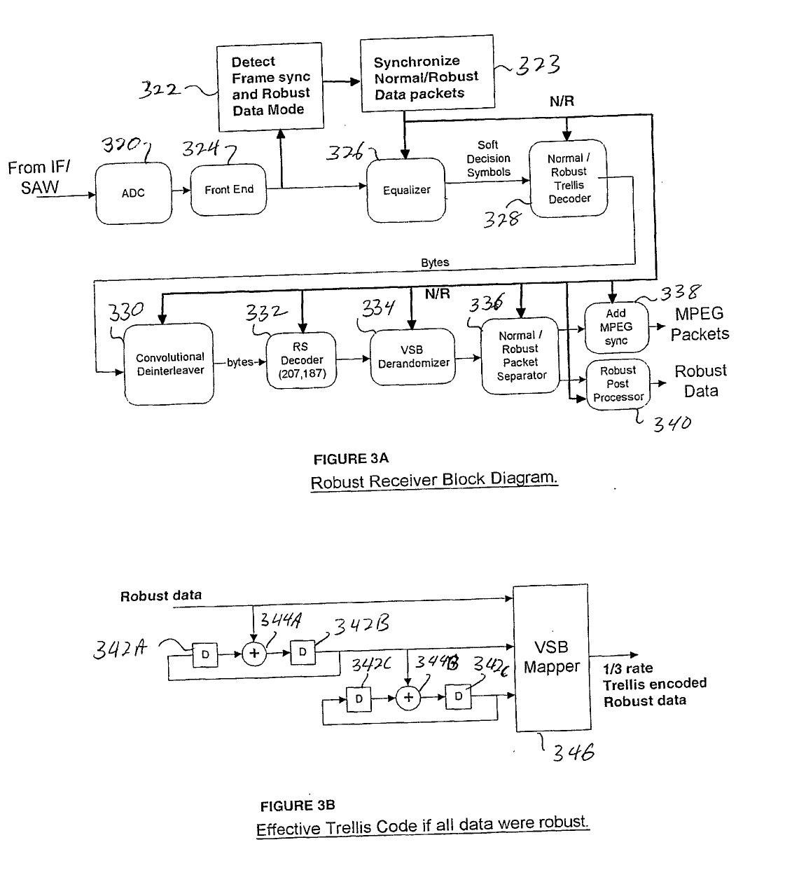

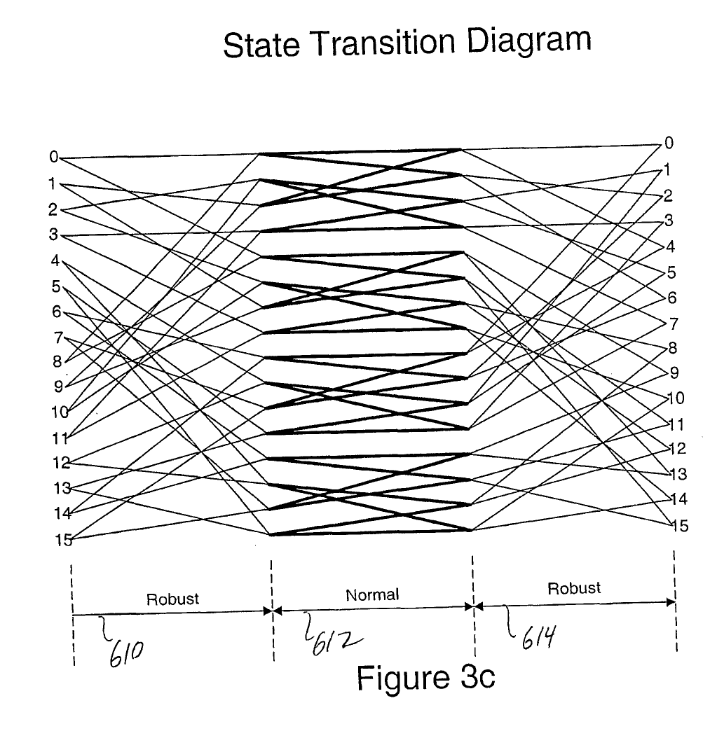

The system multiplexes normal and robust modes by switching between robust data packets and normal data packets. FIG. 3c shows the state transitions of the trellis when hierarchical transmission is present. Intervals 610 and 614 are the state transitions when a robust symbol is transmitted (N/R=1) and interval 612 is the state transition when a normal symbol is transmitted (N/R=0). The darkened lines in interval 612 indicate the presence of parallel transitions.

FIG. 3 is a block diagram of a robust data receiver. The enhanced signal is processed by tuner 310, IF and SAW filters 312 in the normal manner. The demodulator/decoder 314 decodes the received symbols and demultiplexes them to produce a normal packet stream for digital television receiver 316 and a robust packet stream (previously referred to as the high priority data packet stream) for portable device 318. The data packet stream can be received in channel conditions in which the video packet stream is not receivable.

FIG. 3A is a detailed block diagram of the demodulator/decoder 314 in the receiver of FIG. 3. The enhanced VSB signal is digitized by an analog to digital converter 320. The VSB demodulator front-end 324 implements matched filtering, timing and pilot recovely. The front end 324 also provides AGC control to the tuner and IF gain amplifiers. The frame sync detector 322 synchronizes on the frame sync signal and receives the reserved bits from the frame sync representing the 5 bit robust mode tier control code. Having stored the robust mode tier control code, a complete map of VSB-symbols indicating whether each symbol is robust or normal is assembled 323. The resulting N/R signal, which specifies the positions of the robust symbols within the VSB frame and thus defines the transition between normal and robust mode, is made available from synchronization circuit 323 to all other receiver functions. The remainder of the receiver includes ATSC compliant convolution deinterleaver 330, Reed Solomon decoder 332 and VSB derandomizer 334. A normal/robust packet separator 336 separates normal data packets from the robust data packets. MPEG synchronization is added in 338 to robust MPEG packets. Finally a robust data post processor 340 at the receiver performs 184/164 Reed Solomon decoding, which is the reverse operation of the encoder provided by the robust data preprocessor of FIG. 2C located at the transmitting station.

The equalizer 326 is generally a DFE, i.e., a decision feedback equalizer. A DFE trains the equalizer 326 using the extra reliability of the robust symbols for difficult terrestrial channels. Note that the robust symbols provide an extra 5-6 dB of training margin. It outputs soft-decision symbols and an associated N/R signal to specify whether the symbol is a normal or a robust symbol.

The Normal/Robust trellis decoder 328 is in accordance with the A/53 specification (U.S. provisional patent application serial No. 60/280,944, filed Apr. 2, 2001) for normal symbols. For the robust symbols, Normal/Robust trellis decoder 328 implements trellis decoding for the trellis code illustrated in FIG. 3B. As shown in FIG. 3B, robust data is encoded in first trellis encoder 342A, 344A and 342B. The output of the first trellis encoder is further encoded in a second trellis encoder 342C, 344B and 342C. Note that the trellis decoder gets interrupted as it switches back and forth between normal and robust symbols. An effective method to implement a trellis decoder for both cases is to carry ‘parallel transitions’ for the normal trellis within the scope of the robust trellis.

As described earlier, there is a phase ambiguity in the symbols corresponding to the Reed Solomon parity bytes for the robust data packets if a systematic Reed Solomon encoder is used. Note that this ambiguity would require making a decision between two possibilities for the symbol, which result in making a decision on one of two subsets. This decision can be made on either symbol by symbol basis or on a block basis.

If a non-standard Reed Solomon encoder is used in the transmitter, then there is no phase ambiguity. The non-standard Reed Solomon encoder does involve reordering of the information bytes, which must be reversed at the receiver. Since the reordering is based on the position of the packet within a frame, which is known uniquely at the receiver, the reordering can be reversed easily. However, as previously indicated, a non-standard Reed Solomon code would not be compatible with existing transmitters and thus would necessitate modification of existing transmitters.

The rest of the blocks in the diagram of the robust data receiver of FIG. 3A are the inverse of the blocks described for the encoder. The ATSC convolutional deinterleaver 334 performs the inverse of the ATSC convolutional interleaver, and keeps track of Normal/Robust flag. The Reed Solomon decoder 332 operates on the normal packets only. The Reed Solomon decoder for the robust data packets are bypassed, i.e., parity bytes are stripped and only the information bytes are send (note if the non-standard Reed Solomon encoder is used, then a different byte reordering per packet within a frame is implemented before stripping the parity bytes). In the latter case, it provides the N/R signal for the VSB derandomizer, which operates on both the normal and robust bytes.

The output of the derandomizer is sent to the Normal/Robust packet separator 336, which first collects the normal and robust data packets in separate buffers. For normal packets, an MPEG sync is added 338 and sent as a normal MPEG packet. For robust bytes, first the three-byte header for every 187-byte packet is removed, resulting in 184 byte packets. Then two 184-byte packets are collapsed into one 184-byte packet according to the encoding described within the robust packet preprocessor. The resulting 184-byte packet is then sent to the robust postprocessor. The robust post-processor performs Reed Solomon (184,164) decoding. It also performs MPEG sync replacement if robust_payload_type indicates MPEG protocol.

What is claimed is:

1. In a communications system responsive to first data, said communications system encoding said first data by a first encoding method, a method for transmitting second data over said communications system, said method comprising:
encoding said second data by a second encoding method to form encoded second data;
multiplexing said encoded second data with said first data to form multiplexed data; and
transmitting said multiplexed data over said communications system, whereby said first data is encoded by said first encoding method and said second data is encoded by said first encoding method and said second encoding method.

2. A method in accordance with claim 1, wherein said first encoding method is rate 2/3 trellis encoding.

3. A method in accordance with claim 2, wherein said second encoding method is rate 1/2 trellis encoding.

4. A method in accordance with claim 3, wherein said communications system further includes integral pre-coding of data prior to said first encoding method, said method further comprising:
processing said second data by differentiating said second data so as to defeat said integral pre-coding of data when said encoded second data is transmitted over said communications system.

5. A method in accordance with claim 4, further comprising the step of selectively inverting or not inverting said first data transmitted over said communications system to cancel phase errors generated by differentiating said second data.

6. A method in accordance with claim 1, wherein said communications system further includes MPEG packets having an MPEG packet length, said method further comprising:
dividing said second data into second data packet lengths, each of said second data packet lengths being smaller than said MPEG packet length; and
attaching header bytes to each of said second data packets, each of said header bytes corresponding to a NULL packet header, said header bytes being encoded as said first data; and
encoding each of said second data packets as said second data.

7. a method in accordance with claim 1, further comprising:
dividing said second data into a plurality of robust data packets;
computing Reed Solomon parity bytes for each of said plurality of robust data packets;
transmitting each of said Reed Solomon parity bytes for each of said plurality of robust data packets as said first data; and
transmitting each of said robust data packets as said second data.

8. A method in accordance with claim 1, further comprising:
dividing said second data into a plurality of data packets;
computing Reed Solomon parity bytes for each of said plurality of data packets;
combining each of said Reed Solomon parity bytes with each respective ones of said plurality of data packets to form a respective plurality of robust data packets; and
transmitting each of said robust data packets as said second data.

9. In a communications system responsive to first data, said communications system encoding said first data in a first encoder, an improvement for transmitting second data over said communications system, said improvement comprising:
a second encoder responsive to said second data to form encoded second data; and
a multiplexer responsive to said encoded second data and said first data to form multiplexed data; wherein
said transmitter is coupled to said multiplexer to'transmit said multiplexed data over said communications system,
whereby said first data is encoded by said first encoder and said second data is encoded by said first encoder and said second encoder.

10. An apparatus in accordance with claim 9, wherein said first encoder is rate 2/3 trellis encoder.

11. An apparatus in accordance with claim 10, wherein said second encoder is rate 1/2 trellis encoder.

12. An apparatus in accordance with claim 11, wherein said communications system further includes an integral pre-coder prior to said first encoder, said apparatus further comprising:
a differentiator coupled to said second data so as to defeat said integral pre-coder when said encoded second data is transmitted over said communications system.

13. An apparatus in accordance with claim 12, further comprising an invert/not invert for selectively inverting or not inverting said first data transmitted over said communications system.

14. An apparatus in accordance with claim 9, wherein said communications system further includes MPEG packets having an MPEG packet length, said apparatus further comprising:
means for dividing said second data into second data packet lengths, each of said second data packet lengths being smaller than said MPEG packet length; and
means for attaching header bytes to each of said second data packets, each of said header bytes corresponding to a NULL packet header, said header bytes being encoded as said first data; and
means for encoding each of said second data packet lengths as said second data.

15. An apparatus in accordance with claim 9, further comprising:
means for dividing said second data into a plurality of robust data packets;
means for computing Reed Solomon parity bytes for each of said plurality of robust data packets;
means for transmitting each of said Reed Solomon parity bytes for each of said plurality of robust data packets as said first data; and
means for transmitting each of said robust data packets as said second data.

16. An apparatus in accordance with claim 9, further comprising:
means for dividing said second data into a plurality of data packets;
means for computing Reed Solomon parity bytes for each of said plurality of data packets;
means for combining each of said Reed Solomon parity bytes with each respective ones of said plurality of data packets to form a respective plurality of robust data packets; and
means for transmitting each of said robust data packets as said second data.
